(19) United States
(12) Patent Application Publication
(10) Pub. No.: US 2005/0209964 A1
(43) Pub. Date: Sep. 22, 2005

(54) Method of Providing Secure Payment and Transaction Reconciliation

(76) Inventors: Robert M. Allen, Dallas, TX (US); Fritz Onken, Lawrenceville, GA (US); Philip Skarston, Santa Barbara, CA (US)

Correspondence Address: SMITH & HOPEN PA, 15950 BAY VISTA DRIVE, SUITE 220, CLEARWATER, FL, 33760, US

(21) Appl. No.: 10/708,247

(22) Filed: Feb. 19, 2004

Related U.S. Application Data
(60) Provisional application No. 60/481,140, filed on Jul. 25, 2003.

(51) Int. Cl. G06F 17/60

(52) U.S. Cl. 705/40

(57) ABSTRACT

A method of paying a merchant for a claim service provided to a claimant. The method including the steps of receiving a request from a merchant for a payment associated with a claim, generating a claim identifier, generating a payment number having a predetermined limit amount and a predetermined expiration date, associating the claim identifier with the payment number and transmitting the payment number to the merchant for payment of the claim.

### CROSS-REFERENCE TO RELATED APPLICATION

This application claims priority from U.S. provisional application Ser. No. 60/481,140, entitled: “Stored Value Card Reconciliation Method,” filed Jul. 25, 2003.

### BACKGROUND OF INVENTION

This invention relates to a method of providing fraud protection and reconciliation for credit card transactions relating to warranty and insurance claim payments.

When an insured needs a repair or replacement product, many service institutions require the insurance company to provide a credit card so that immediate payment is made. While the insurance company might prefer to send a check, the delay in printing, delivering, depositing and clearing such funds are not attractive to the service provider. The benefit of receiving credit card information is the speed in which funds and payment can be guaranteed.

The insurance company might take several approaches when providing credit card information. The insurance company may fax the service institution the credit card number with the authorized amount or call the service institution and read the number over the telephone. Frequently, the service institution and insurance company may disagree on what each considers appropriate charges. For example, in the case of a vehicle breakdown, the insurance company may agree to pay for a new water pump for the car but not for the charge to tow the car to the service bay. Often, the service institution, once in possession of the credit card information, will charge for work not authorized by the insurance company. Alternatively, the service institution may undercharge the credit card in view of the amount authorized. The inconsistency and fraud perpetrated on the insurance company and the credit card institution that issued the card results in substantial losses, particularly in view of the substantial amounts involved in warranty claims.

When the insurance company receives the credit card bill, the information contained in the statement is severely limited for reconciliation purposes. A single insurance company credit card statement may have thousands of different claim charges. Matching each charge by service institution and amount is often cumbersome if not impossible. As noted above, service institutions may overcharge or undercharge the authorized amount. Thus, there are no matching transactions to reconcile. Furthermore, if the service institution is a franchise multiple claims may be charged under the same franchise name, making reconciliation even more difficult.

What is needed in the industry is an improved means through which claim service contract administrators, such as insurance companies, can provide payments to service providers or merchants. A method of payment is needed that provides swift payment to the merchant while still providing protection against overcharges to the service administrator. Additionally, a method is needed that allows the service administrator to reconcile the payments to the merchants to the appropriate claim and contract number.

### SUMMARY OF INVENTION

The long-standing but heretofore unfulfilled need for a method of providing claim payments to merchants that reduces fraud and provides reconciliation benefits is now fulfilled by a new, useful, and nonobvious invention.

The present invention is a method of providing a distinct payment number for the purpose of replacing the current process for insurance and warranty claim payments via credit card. The payment number has a fixed charge limit, variable expiration options, the ability to track directly with claim and contract information, and the ability to upload into administration systems. It is within the scope of the present invention to provide both a physical payment number, as commonly associated with a credit card, and a virtual payment number.

In accordance with the present invention, a method of paying a merchant for a claim service provided to a claimant is provided. The method includes, receiving a request from a merchant for a payment associated with a claim, generating a claim identifier, generating a payment number having a predetermined limit amount and a predetermined expiration date, associating the claim identifier with the payment number, and transmitting the payment number to the merchant for payment of the claim.

The claim received from the merchant could be related to a service rendered, a replacement product required, or both a service and a replacement product required to complete a repair.

In one embodiment of the invention, the merchant provides an estimated cost of the repair. The estimated cost of repair can then be used to determine the limit amount associated with the payment number. The limit may be equal to the estimate provided by the merchant, or the limit amount may also be based upon limit amounts associated with similar types of repairs in the industry.

When a request is received from a merchant, verification of coverage may be provided. The coverage verification provides the merchant with a guarantee that the services provided to the claimant are covered under a valid contract with a service contract administrator. The claimant contract number can then be associated with the claim number to be included in the claim identifier.

The claim identifier of the present invention may include the claim number, the contract number, the payment number and associated limit amount, and the expiration date of the payment number. Additional data may also be stored with the claim identifier to include the merchant number, purchase order number, or any other features useful in identifying the claim.

After the claim identifier has been established and associated with the payment number, the payment number is provided to the merchant for payment of the claim. The merchant then utilizes the payment number to submit a transaction amount associated with the service provided. The merchant receives the payment and the merchant payment is tracked and reconciled with the payment number and the claim identifier.

Additionally, the merchant payment request may also be assigned an acceptance code. The acceptance code is used to provide either approval or denial of the limit amount associated with the payment number transmitted. The approval or denial is based upon the availability of funds for payment. The method of the present invention also includes verification of a valid date based on the expiration date associated with the payment number. The acceptance code is associated with the merchant payment, which is then used in the reconciliation process.

According to one embodiment of the present invention, the method further includes requesting a load of funds equal to the predetermined limit amount, executing the load of funds, generating a confirmation of the load of funds execution, and reconciling the payment number and the claim identifier with the confirmation of the load of funds execution.

In accordance with an additional embodiment of the present invention, a payment number having a predetermined limit amount and a predetermined expiration date is selected from a predetermined group of payment numbers. Accordingly, the payment number can be reused after a time sufficient to guarantee that all transactions have been reconciled that are associated with a particular payment number. Additionally, a group of payment numbers may be assigned to a specific service contract administrator.

The method of the present invention may be utilized to provide payment to a merchant relating to an insurance claim or to a warranty claim.

The payment number in accordance with the present invention may be a credit card number.

In a preferred embodiment of the present invention, a method of paying a merchant for a claim service provided to a claimant is provided, wherein the method includes, receiving a request from a merchant for a payment associated with a claim, the request further comprising an estimate for repair, verifying that the request received from the merchant is covered under a contract associated with the claimant, establishing a predetermined limit amount for the repair, generating a claim identifier, selecting a payment number, the selected payment number having the predetermined limit amount and a predetermined expiration date, associating the claim identifier with the selected payment number, transmitting the payment number to the merchant for payment of the claim, providing funding for the predetermined limit amount associated with the selected payment number, tracking a transaction amount associated with the selected payment number, and reconciling the payment number and the claim identifier with the transaction amount. Accordingly, the method further includes tracking a plurality of transaction amounts and reconciling the payment number and the claim identifier with the plurality of transaction amounts.

An advantage of the present invention is the elimination of over charges due to fraud or oversight. The present invention establishes a predetermined limit amount and an expiration date associated with a payment number. Providing this payment number to the merchant eliminates the possibility of overcharging for the service provided because the authorized charge amount is bounded by the predetermined limit amount.

Another advantage of the present invention is the elimination of the costs associated with the reconciliation processes. According to the present invention, a claim identifier is associated with each claim. By associating the claim identifier with the payment number, the service contract provider can easily reconcile the transactions to the appropriate claims thereby greatly reducing the time required for reconciliation by prior art methods.

### BRIEF DESCRIPTION OF DRAWINGS

For a fuller understanding of the nature and objects of the invention, reference should be made to the following detailed description, taken in connection with the accompanying drawings, in which:

FIG. 1 is a flow diagram of the payment method in accordance with the present invention;

FIG. 2 is a detailed flow diagram of the payment method in accordance with the present invention;

FIG. 3 is a diagram illustrating the reconciliation features in accordance with the present invention; and

FIG. 4 is an exemplary illustration of a payment method in accordance with the present invention.

### DETAILED DESCRIPTION

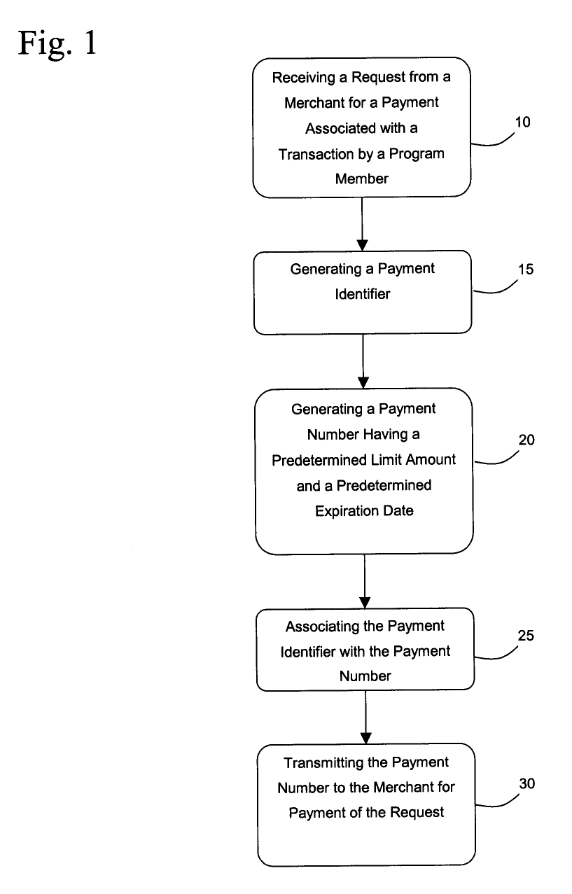

Referring to FIG. 1, the method in accordance with the present invention includes receiving a request from a merchant for a payment associated with a claim 10. The claim may be for a service provided by the merchant or for replacement parts. A claim identifier is generated 15. The claim identifier may consist of a plurality of elements including the claim number, contract number, merchant information, claims adjustor number or any additional information that would be effective in identifying the claim. A payment number is generated having a predetermined limit amount and a predetermined expiration date 20. The payment number is then associated with the payment number 25. The association may be established through a database structure as is commonly known in the art. The payment number is then transmitted to the merchant to satisfy payment of the claim 30. With this method, the service administrator responsible for payment of the claim is provided with assurance that the claim amount will not exceed the predetermined limit amount. Additionally, the service administrator is provided with claim information associated with a specific payment number to facilitate reconciliation of the payments to the appropriate claims.

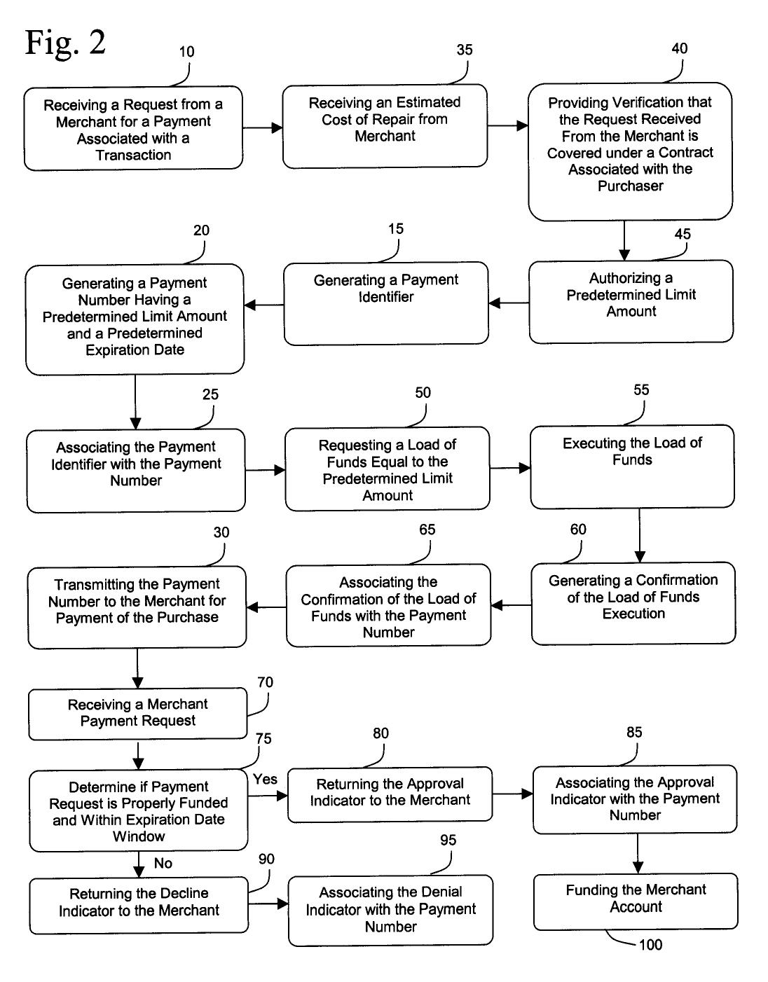

Funding confirmation and transaction event tracking may also be provided in accordance with the present invention. Referring to FIG. 2, the method in accordance with the present invention includes receiving a request from a merchant for a payment associated with a claim 10. In addition to the request, an estimated cost of repair is received from the merchant 35. Verification is provided that the request received from the merchant is covered under an effective contract associated with the claimant 40. The service provider can provide this verification. A predetermined limit amount is then authorized based on the estimate provided and possibly additional historical data regarding the requested service 45. A claim identifier is generated 15. A payment number is then generated having the predetermined limit amount and a predetermined expiration date 20. The payment number is then associated with the claim identifier 25. A request is then sent to load funds equal to the predetermined limit amount 50. The load of funds may be requested by the service contract administrator to the payment number processor. The payment number processor may then request the load of funds from the bank responsible for funding the payment number as is typical with a credit card transaction process. The load of funds is the executed 55 as requested and a confirmation of the load of funds in generated 60. The confirmation of the load of funds is then associated with the payment number 65 thereby providing additional reconciliation information. The payment number is then transmitted to the merchant to satisfy payment of the claim 30. Upon receipt of a merchant request for payment, a determination is made as to whether or not the payment request is properly funded and that the request is within the expiration date window for the payment number 75. If the payment request is properly funded and within the expiration date, an approval indicator is returned to the merchant 80, the approval indicator is associated with the payment number for reconciliation purposes 85 and the merchant account is funded 100. If the payment request is not properly funded or the expiration date has passed, a denial indicator is returned to the merchant 90 and a denial indicator is associated with the payment number for reconciliation 95. This process would be followed for each load request and each merchant payment request, thereby establishing a reconciliation transaction repository including the claim identifier, the payment number and the plurality of transactions.

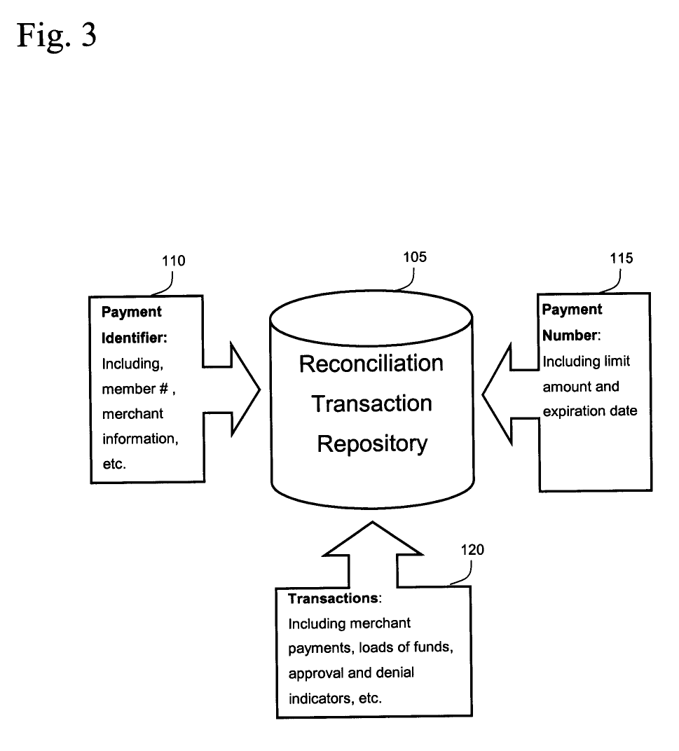

Detail of such a reconciliation transaction repository is as shown in FIG. 3, in which the components of the claim identifier, including the claim number, contract number, merchant information 110 are stored in a reconciliation transaction repository 105. The payment number 115 including the limit amount and the expiration date is then associated with the claim number in the reconciliation transaction repository 105. The transactions associated with the payment number 120, including merchant payments, loads of funds, and approval and denial indicators are then associated and stored with the claim number and the payment number in the reconciliation transaction repository 105.

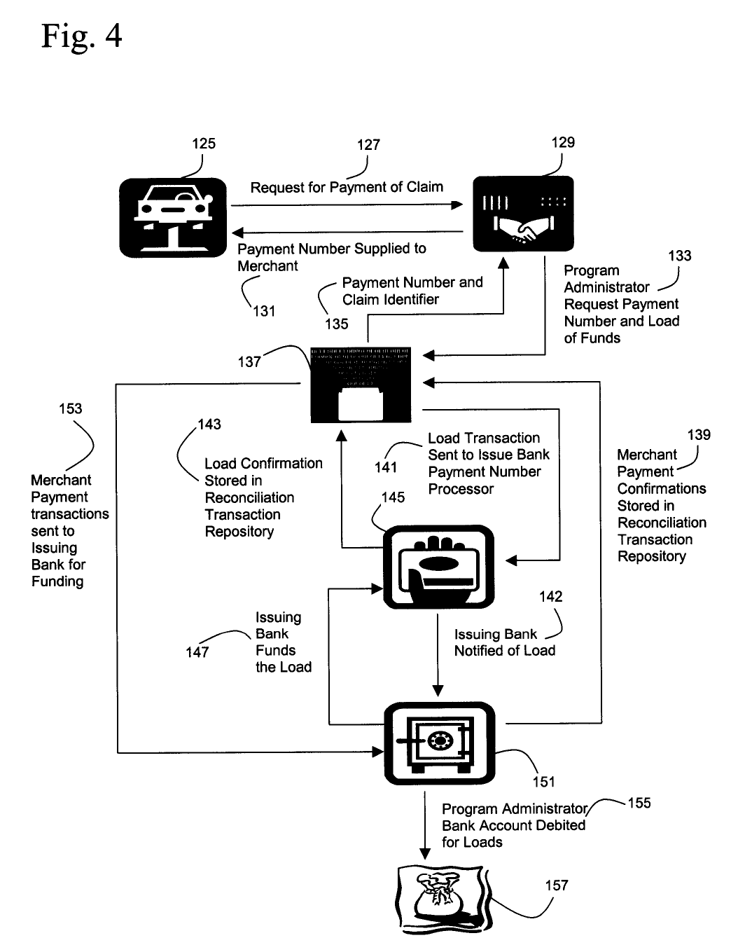

In an exemplary embodiment illustrated in FIG. 4, a service provider 125 submits a request for payment on a claim 127 to a program contract administrator 129. The program administrator requests a payment number and load of funds 133. The payment number and the claim identifier are stored in the reconciliation transaction repository 137. The payment and confirmation number are returned 135 to the program administrator 129. The payment number is then supplied to the merchant 131. A load transaction request 141 is sent to the payment number processor 142 associated with the bank responsible for issuing the payment number 151. A confirmation of the load is returned 143 and stored in the reconciliation transaction repository 137. The issuing bank 151 is notified of the load 149 and funds the load 147. Merchant payment transactions are sent to the issuing bank for funding 153. Confirmations of the merchant payments are then transmitted 139 and stored in the reconciliation transaction repository 137. The program administrator bank account 157 is debited for the processed loads 155.

As is common is financial transaction processing, a daily sweep of the bank accounts can be taken and the appropriate transactions recorded and transmitted at that time.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

1. A method of paying a merchant for a claim service provided to a claimant, the method comprising the steps of:
receiving a request from a merchant for a payment associated with a claim;
generating a claim identifier;
generating a payment number having a predetermined limit amount and a predetermined expiration date;
associating the claim identifier with the payment number; and
transmitting the payment number to the merchant for payment of the claim.

2. The method of claim 1, wherein the claim is for a service rendered.

3. The method of claim 1, wherein the claim is for a replacement product received.

4. The method of claim 1, wherein receiving a request from a merchant for a payment associated with a claim further comprises, receiving an estimated cost of repair from the merchant.

5. The method of claim 1, further comprising providing verification that the request received from the merchant is covered under a contract associated with the claimant.

6. The method of claim 1, wherein generating a payment number having a predetermined limit amount and a predetermined expiration date further comprises:
receiving an estimated cost of repair from the merchant; and
authorizing the predetermined limit amount.

7. The method of claim 1, wherein generating the claim identifier further comprises;
identifying a contract number assigned to a claimant;
generating a claim number; and
associating the claim number with the contract number.

8. The method of claim 1, further comprising after transmitting the payment number to the merchant for payment of the claim:
tracking at least one merchant payment associated with the payment number; and
associating the payment number and the claim identifier with the at least one merchant payment.

9. The method of claim 8, further comprising prior to tracking the at least one merchant payment:
transmitting a merchant payment request;
assigning an acceptance code to the merchant payment request; and
associating the acceptance code with the merchant payment.

10. The method of claim 1, further comprising:
requesting a load of funds equal to the predetermined limit amount;
executing the load of funds;
generating a confirmation of the load of funds execution; and
reconciling the payment number and the claim identifier with the confirmation of the load of funds execution.

11. The method of claim 1, wherein generating a payment number having a predetermined limit amount and a predetermined expiration date, further comprises selecting the payment number from a predetermined group of payment numbers.

12. The method of claim 11, wherein the group of payment numbers is assigned to a service contract administrator.

13. The method of claim 1, wherein the claim is an insurance claim.

14. The method of claim 1, wherein the claim is a warranty claim.

15. The method of claim 1, wherein the payment number is a credit card number.

16. A method of paying a merchant for a claim service provided to a claimant, the method comprising the steps of:
receiving a request from a merchant for a payment associated with a claim, the request further comprising an estimate for repair;
verifying that the request received from the merchant is covered under a contract associated with the claimant;
establishing a predetermined limit amount for the repair;
generating a claim identifier;
selecting a payment number, the selected payment number having the predetermined limit amount and a predetermined expiration date;
associating the claim identifier with the selected payment number;
transmitting the payment number to the merchant for payment of the claim;
providing funding for the predetermined limit amount associated with the selected payment number;
tracking a transaction amount associated with the selected payment number; and
reconciling the payment number and the claim identifier with the transaction amount.

17. The method of claim 16, wherein tracking a transaction amount further comprises, tracking a plurality of transaction amounts and reconciling the payment number and the claim identifier with the plurality of transaction amounts.
